(19) United States
(12) Patent Application Publication
(10) Pub. No.: US 2002/0139904 A1
(43) Pub. Date: Oct. 3, 2002

(54) Swing away mailbox support

(76) Inventor: James Lowell, Lake Linden, MI (US)

Correspondence Address: MICHAEL BEST & FRIEDRICH, LLP, 100 E WISCONSIN AVENUE, MILWAUKEE, WI, 53202, US

(21) Appl. No.: 09/822,712

(22) Filed: Mar. 30, 2001

(51) Int. Cl. A47J 47/16

(52) U.S. Cl. 248/145; 248/132; 248/417; 248/125.7

(57) ABSTRACT

A swinging mailbox support including a vertical member having a horizontal arm disposed thereon wherein a mailbox is affixed to an end portion of the horizontal arm and furthermore the assembly comprises two portions pivotably interconnected and tending to maintain a neutral initial state by the action of gravity. In operation the arm supporting the mailbox is free to rotate about an inclined axis in the event of a collision with a vehicle or other object Because of the inclined axis, rotation causes the mailbox to rise to a higher level above the ground. Once free of the impacting object, gravity restores the mailbox to a service position.

### BACKGROUND OF THE INVENTION

This invention relates to mailbox supports and particularly to one that can swivel when impacted from the side.

Mailbox supports generally consist of a horizontal arm which supports the mailbox at a convenient height for access. The horizontal arm is often attached to a post anchored in the ground adjacent to the road. In areas where snowplows frequent roadways, it is not uncommon for mailboxes to be damaged from either impact with the plow or snow from the plow. The above-described rigid structure is not only very susceptible to damage under such conditions, but may be very difficult and costly to replace when the ground is frozen or snow covered.

Various devices have been invented to solve this problem, most commonly with a swinging support for the mailbox. Most of these devices use a vertical pivot axis and move the mailbox in a generally horizontal plane. Most of the devices include either a complex return mechanism using springs and the like, or require manual readjustment of the mailbox support after it has been pivoted.

### SUMMARY OF THE INVENTION

The present invention provides a mailbox support including a generally vertical portion adapted to be interconnected with the ground a first pivot member mounted to the vertical portion, a generally horizontal portion adapted to support a mailbox in a rest position, and a second pivot member mounted to the horizontal portion and pivotably interconnected with the first pivot member. The first and second pivot members define a non-horizontal and non-vertical pivot axis about which the horizontal portion pivots in the event of a force being applied to the horizontal portion. The horizontal portion returns to the rest position under the influence of gravity due to the non-horizontal and non-vertical pivot axis.

### BRIEF DESCRIPTION OF THE DRAWINGS

FIG. 1 is a side elevation view of a mailbox support structure embodying the present invention.

FIG. 2 is a perspective view of the mailbox support structure of FIG. 1.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter. The use of letters to identify elements of a method or process is simply for identification and is not meant to indicate that the elements should be performed in a particular order.

### DETAILED DESCRIPTION OF THE PREFERRED EMBODIMENT

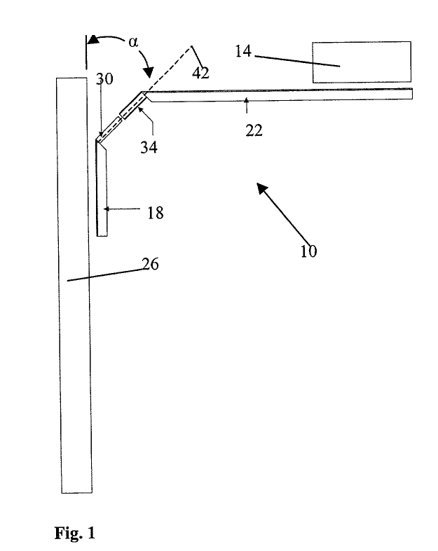

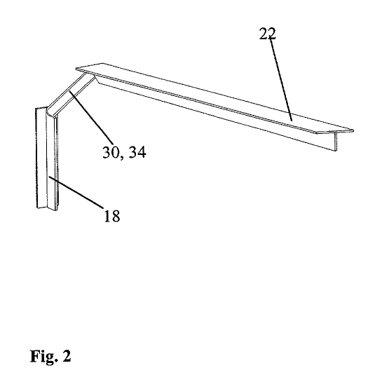

FIGS. 1 and 2 illustrate a mailbox support structure 10 supporting a mailbox 14. The support structure 10 includes a generally vertical portion 18 and a generally horizontal portion 22 to which the mailbox 14 is mounted. The vertical portion 18 may be constructed of steel Tbar with holes drilled to facilitate attachment to a wooden post 26. The horizontal portion 22 may also be constructed of steel Tbar with holes drilled to facilitate attachment of the mailbox 14.

The support structure 10 also includes a first pivot member 30 mounted to the vertical portion 18 and second pivot member 34 mounted to the horizontal member 22. Preferably, the pivot members 30, 34 are constructed of round steel stock and are welded or otherwise permanently affixed to the respective vertical and horizontal portions 18, 22. The first pivot member 30 is oriented at a non-vertical and non-horizontal angle a to define a pivot axis 42. The angle α is preferably between about 25° and 65° with respect to vertical, and is ideally set according to the weight of the mailbox 14 and the length of the horizontal member 22 to ensure sufficient return force due to gravity and sufficient horizontal movement to move the mailbox away from an external horizontal force.

The pivot members 30, 34 are sized such that the second pivot member 34 fits snugly over the first pivot member 30 without excessive play to facilitate rotation of the second pivot member 34 with respect to the first pivot member 30 and to discourage the accumulation of rain or other precipitation in the second pivot member 34. Grease may be applied to the first pivot member 30 to facilitate such rotation while reducing wear on the parts. The first and second pivot member 30, 34 are designed such that the horizontal portion 22 may be lifted off the first pivot member 30 for maintenance or repair.

In operation, the horizontal portion 22 is normally in the at-rest position illustrated in FIGS. 1 and 2, and is held in this position under the influence of gravity acting on the horizontal portion 22 and mailbox 14. In the event of a force being applied to the horizontal portion 22, including a force on the mailbox 14 that is transferred to the horizontal portion 22, the horizontal portion 22, mailbox 14, and second pivot member 34 will all pivot together about the pivot axis 42. In this regard, each point on the horizontal portion 22 moves in a plane generally perpendicular to the pivot axis 42, and the horizontal portion 22 may therefore be said to pivot in a perpendicular plane.

Such pivoting permits the force (e.g., a snowplow passing by and bumping the mailbox 14) to pass as the mailbox 14 is pivoted out of the way, and reduces the severity of the damage incurred by the mailbox 14. Once the force has passed or decreased sufficiently, the mailbox 14, horizontal arm 22, and second pivot member 34 return to the at-rest position under the influence of gravity.

As an added consideration, a locking mechanism may be provided that couples the horizontal portion 22 to the vertical portion 18 to resist the removal of the horizontal portion 22 from the vertical portion 18. Such a locking mechanism may include, for example, a chain and padlock assembly. The chain should have enough slack in it to permit the horizontal portion 22 to pivot through a range of motion sufficient to reduce damage to the mailbox 14 in the event of an impact. Also, rigid (e.g., steel) guards may be mounted to the horizontal portion 22 on either side of the mailbox 14 to further reduce damage to the mailbox 14.

1. A mailbox support comprising:
a generally vertical portion adapted to be interconnected with the ground;
a first pivot member mounted to said vertical portion and defining a non-horizontal and non-vertical pivot axis;
a generally horizontal portion adapted to support a mailbox in a rest position; and
a second pivot member mounted to said horizontal portion and pivotably interconnected with said first pivot member to permit pivoting of said horizontal portion from said rest position about said pivot axis in response to force being applied to said horizontal portion, said horizontal portion returning to said rest position under the influence of gravity.

2. The mailbox support of claim 1, wherein said first and second pivot members include cylindrical member in nesting relationship with each other.

3. The mailbox support of claim 1, wherein said first and second pivot members are coupled under the influence of gravity and may be uncoupled by moving said horizontal portion generally parallel to said pivot axis.

4. The mailbox support of claim 1, further comprising a locking mechanism coupling said horizontal portion to said vertical portion to resist removal of said horizontal portion from said vertical portion.

5. The mailbox support of claim 4, wherein said locking mechanism includes a chain and padlock assembly.

6. The mailbox of claim 1, wherein said pivot axis is disposed at an angle of between about 25-65° with respect to vertical.
